(19) United States
(12) Patent Application Publication
(10) Pub. No.: US 2010/0042380 A1
(43) Pub. Date: Feb. 18, 2010

(54) CAD/CAE SYSTEM AND METHOD FOR DESIGNING AND ANALYZING UBIQUITOUS SYSTEMS

(75) Inventors: Suk-hwan Suh, Pohang-si (KR); Su-ho Jeong, Pohang-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: POSTECH ACADEMY-INDUSTRY FOUNDATION, Pohang-si (KR)

(21) Appl. No.: 12/535,111

(22) Filed: Aug. 4, 2009

(30) Foreign Application Priority Data
Aug. 13, 2008 (KR) 10-2008-0079594

(51) Int. Cl. G06F 17/50; G06F 17/30

(52) U.S. Cl. 703/1; 707/104.1

(57) ABSTRACT

Provided are a computer-aided design (CAD)/computer-aided engineering (CAE) system and a method for designing and analyzing a ubiquitous system. The CAD/CAE system includes: a design system which generates a system model in a 3-layer structure including an environment layer defining environmental elements and physical structures of the ubiquitous system, a component layer defining devices constituting the ubiquitous system, and a scenario layer representing behaviors of components of the ubiquitous system, and re-defines the system model in order to define a plurality of design alternatives; a simulator which is connected to the design system to simulate the system model designed by the design system; and an analysis system which is connected to the simulator to analyze results of the simulation performed by the simulator and recommend an optimal design alternative.

### BACKGROUND

The present invention relates to a computer-aided design (CAD)/computer-aided engineering (CAE) system and a method for designing and analyzing a ubiquitous system, and more particularly, to a CAD/CAE system and a method for performing a simulation with respect to a performance and an operation of a ubiquitous system according to various design conditions of the ubiquitous system, analyzing the simulation results, and recommending an optimal design alternative so as to assist a system engineer to easily design an optimized ubiquitous system.

Due to the rapid development of computer, mobile, network, and system integration technologies, modern technology has become ubiquitous in society throughout every area of modern life. In modern society, various types of computers have penetrated into every kin of thing and environment and yet are still connected to one another through a network. Thus, these various types of ubiquitous computers will improve the overall quality of life for everyone in society. Ubiquitous technology has been applied to various fields such as u-City, u-Home, u-Office, u-Campus, u-Government, u-Health, and the like, and will greatly affect the manufacturing industry.

A ubiquitous system is a set of a person, an object, and a process necessary for accomplishing a purpose using ubiquitous technology. The establishment of such a ubiquitous system has various difficulties such as cost, size, complexity, and the like. In other words, prices of hardware or software necessary for establishing the ubiquitous system are high. If the ubiquitous system has a large size, a large amount of cost is required for revising errors in the design of the ubiquitous system, once the ubiquitous system is established. Since interactions among components of the ubiquitous system are complicated, time and cost problems occur due to the trial and error process that accompanies the establishment of the ubiquitous system. The design of the ubiquitous system is heavily dependent on the experience of the system developer.

Therefore, there is a need for the development of computer-aided technologies (CAx), including computer-aided design (CAD), computer-aided manufacturing (CAM), computer-aided engineering (CAE), and the like, which can assist a system engineer to design, analyze, and simulate a ubiquitous system so as to effectively be able to establish the ubiquitous system.

A conventional CAx tool may generally fall into several categories, such as a system engineering tool for a general system, a simulator specialized for a network of ubiquitous technology, and a simulator for a ubiquitous system. Characteristics and advantages of conventional CAx tools will now be described in brief based on the classification.

Table 1, below, shows comparison and analysis results of characteristics of CAx tools in terms of their usefulness to development purposes, system engineering, and applied technologies. The system engineering category includes a comparison of elements of design, simulation, analysis, and evaluation. The applied technology category includes a comparison of elements of a wireless local area network (WLAN), a wireless personal area network (WPAN), a radio frequency identification (RFID), security, and context awareness. Each comparison item can be categorized based on its supportiveness or non-supportiveness and degrees of supportiveness.

TABLE 1

| | | | | | | Applied Technology | | | | |
|---|---|---|---|---|---|---|---|---|---|---|
| | Development | System Engineering | | | | | | | | Context |
| Tool | Purpose | Design | Simulation | Analysis | Evaluation | WLAN | WPAN | RFID | Security | Awareness |
| ARENA | Model and | | | | | X | X | X | X | X |
| | analyze business, | | | | | | | | | |
| | service, or | | | | | | | | | |
| | manufacturing | | | | | | | | | |
| Promodel | Discrete event | | | | | X | X | X | X | X |
| | simulation | | | | | | | | | |
| | software | | | | | | | | | |
| Ns2 | Discrete event | ◯ | | | X | | | | X | X |
| | simulation for | | | | | | | | | |
| | TCP, routing, and | | | | | | | | | |
| | multicast protocols | | | | | | | | | |
| QualNet | High-Q network | ◯ | | | X | | | | | |
| | evaluation | | | | | | | | | |
| | software | | | | | | | | | |
| UbiWise | User interface test | Δ | | X | X | N/A | X | X | X | |
| | wireless device | | | | | | | | | |
| | and protocol | | | | | | | | | |
| | between mobile | | | | | | | | | |
| | devices | | | | | | | | | |
| UbiREAL | Simulation and | Δ | | | X | | | | X | |
| | test ubiquitous | | | | | | | | | |
| | application in | | | | | | | | | |
| | various situations | | | | | | | | | |
| TATUS | Virtual ubiquitous | Δ | | | X | X | X | X | X | |
| | computing | | | | | | | | | |
| | environments for | | | | | | | | | |
| | supporting SUT | | | | | | | | | |
| iCAP | System for | ⋄ | ⋄ | X | X | X | X | X | X | |
| | supporting user to | | | | | | | | | |
| | remanufacture | | | | | | | | | |
| | context awareness | | | | | | | | | |
| | application | | | | | | | | | |
| | without coding | | | | | | | | | |
| | work | | | | | | | | | |
| aCAP- | Context awareness | ⋄ | ⋄ | | X | X | X | X | X | |
| pella | application for | | | | | | | | | |
| | supporting to final | | | | | | | | | |
| | user perform | | | | | | | | | |
| | programming | | | | | | | | | |
| Rifidi | Too for selecting | | | ◯ | X | N/A | N/A | | N/A | N/A |
| | and constituting | | | | | | | | | |
| | RFID reader and | | | | | | | | | |
| | tag | | | | | | | | | |

: strongly satisfied,
◯: weakly satisfied,
Δ: partly satisfied,
⋄: satisfied in different manner,
X: unsatisfied

A system engineering tool for a general system, not for a ubiquitous system, includes “ARENA,” “Promodel,” and the like. These tools process, model, and simulate the ubiquitous system, not components of the ubiquitous system. The system engineering tool provides various statistical analysis functions of analyzing simulation results and functions of comparing and analyzing several design alternatives so as to support a system engineer to systematically derive an optimal design. These tools provide sufficient system engineering functions, but are based on a process of analyzing the general system. Thus, these tools do not support the detailed technical analyses that are important parts in the ubiquitous system.

Simulators specialized for a network of ubiquitous technology includes “Nx2,” “QualNet,” and the like. These tools define behaviors of components of the network such as hosts/routers, packets, and the like to constitute networks such as a WLAN, a WPAN, and the like, and simulate interactions between these networks. The simulation results may be analyzed by an event tracer, a trend graph, or the like, which are mainly used to test performances of protocols. These tools select and arrange components of a network system to design the network system. However, the main object of these tools is to test the performance of components of the network system such as protocols, networking devices, and the like. Thus, these tools do not systematically support comparisons, analyses, and an optimal system design of the network system.

A simulator and an emulator for the ubiquitous system may include “UbiWise,” “UbiREAL,” “TATUS,” “iCAP,” “a CAPpella,” “Rifidi,” and the like. These tools design and simulate a system applying network technology and context awareness technology of the ubiquitous technology. However, they do not evaluate several designing alternatives of the system and do not draw an optimal design of the system.

As described above, conventional CAx tools partly support only one of either system engineering or ubiquitous technologies, and can verify a system that is designed through a simulation or the like. However, the conventional CAx tools have insufficient functions of comparing and analyzing various design alternatives.

Accordingly, there is a need for a new concept in CAx technology for supporting system engineering and ubiquitous technologies and comparing and analyzing several verified design alternatives in order to derive an optimal design.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present invention provides a computer-aided design (CAD)/computer-aided engineering (CAE) system and method for performing a simulation with respect to the performance and operation of a ubiquitous system according to various design conditions of the ubiquitous system, analyzing the simulation results, and recommending an optimal design alternative so as to assist a system engineer to easily design an optimized ubiquitous system.

According to an aspect of the present invention, there is provided a computer-aided design (CAD)/computer-aided engineering (CAE) system for designing and analyzing a ubiquitous system, including: a design system which generates a system model in a 3-layer structure including: an environment layer to define environmental elements and physical structures of the ubiquitous system, a component layer to define devices constituting the ubiquitous system; and a scenario layer to represent behaviors of components of the ubiquitous system, which design system re-defines the model of the ubiquitous system in order to present a plurality of design alternatives; a simulator connected to the design system to simulate the system model designed by the design system; and an analysis system connected to the simulator to analyze results of the simulation performed by the simulator and recommend an optimal design alternative.

According to another aspect of the present invention, method of designing and analyzing a ubiquitous system is provided, including: generating a new environment for the ubiquitous system to be designed or reading a pre-stored environment to design an environment for the ubiquitous system; generating each component for use in the ubiquitous system by either selecting a pre-stored standard component or defining a new component, until all necessary components have been selected or defined; combining the components to actually construct the entire ubiquitous system and defining behaviors of the components to set a scenario of the ubiquitous system; simulating one of a performance and an operation of the ubiquitous system according to the set scenario; analyzing the results of the simulation and outputting the analysis results in a graph or chart form; adding and storing system information regarding the defined components and scenario, the simulation results, and analysis information of the simulation results as design alternatives of a design alternative list; and comparing the analyzed outcome of the simulation results of the design alternatives to derive an optimal design alternative.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a computer-aided design (CAD)/computer-aided engineering (CAE) system according to an embodiment of the present invention;

FIG. 2 illustrates a conveyer system using a CAD/CAE system according to an embodiment of the present invention;

FIG. 3 is a flowchart of a process of designing and analyzing the conveyer system of FIG. 2;

FIG. 4 illustrates a screen output in an environment setting operation of the process of FIG. 3, according to an embodiment of the present invention;

FIG. 5 illustrates a screen output in a component generating operation of the process of FIG. 3, according to an embodiment of the present invention;

FIGS. 6A through 6D illustrate scenarios set by the scenario setting operation of the process of FIG. 3, according to embodiments of the present invention;

FIGS. 7A and 7B illustrate screens output in a scenario simulation result analyzing operation of the process of FIG. 3, according to an embodiment of the present invention; and

FIG. 8 illustrates a selection of an optimal design alternative in an optimal design alternative recommending operation of the process of FIG. 3, according to an embodiment of the present invention.

### DETAILED DESCRIPTION

While illustrative embodiments have been illustrated and described, it will be appreciated that various changes can be made therein without departing from the spirit and scope of the invention.

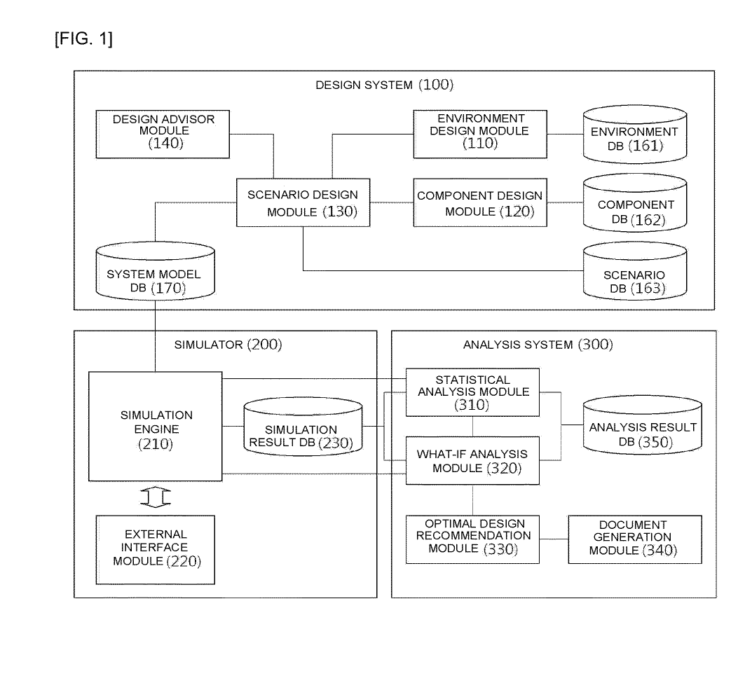

FIG. 1 is a block diagram of a computer-aided design (CAD)/computer-aided engineering (CAE) system according to an embodiment of the present invention. Referring to FIG. 1, the CAD/CAE system for a ubiquitous system according to the present embodiment includes a design system 100, a simulator 200, and an analysis system 300. The design system 100 combines scenario, component, and environment layers to design the ubiquitous system and generate a system model. The simulator 200 is connected to the design system 100 to simulate the system model designed by the design system 100. The analysis system 300 connected to the simulator 200 analyzes the results of the simulation performed by the simulator 200 and recommends an optimal design alternative.

The design system 100 models the ubiquitous system in the environment, component, and scenario layers. The environment layer represents environmental elements (i.e., lighting, temperature, humidity, etc.) and physical structures (i.e., a building layout, a road, etc.) of the ubiquitous system. The component layer represents devices (i.e., a radio frequency identification (RFID) tag, a sensor node, a product, etc.) of the ubiquitous system. The scenario layer represents behaviors of the ubiquitous system, i.e., operations and functions of components of the ubiquitous system. Here, the environment, component, and scenario layers are constituted so that a user may easily change environments and components of the ubiquitous system.

The design system 100 includes an environment design module 110, a component design module 120, a scenario design module 130, and a design advisor module 140. Detailed functions of the environment design module 110, the component design module 120, the scenario design module 130, and the design advisor module 140 will now be described.

The environment design module 110 designs the environment layer of the three layers constituting the ubiquitous system. The environment layer represents the building layout such as a wall, a pillar, and the like and presents physical situations such as temperature, humidity, and the like, using a method of combining 3-dimensional (3-D) grids. For example, the environment layer may combine a 3-D grid representing a layout of a building with a 3-D grid having a temperature value of each lattice to represent a temperature distribution inside and outside the building. This method may vary the kinds of 3-D grids to design various types of systems such as a factory, a hospital, and the like.

The component design module 120 supports the definition of new components for inclusion in the ubiquitous system or changes of actions of existing components. In the present invention, components may include physical components such as an RFID reader, an RFID tag, a sensor node, and the like, and/or networking components such as a network protocol, a network transmission model, and the like. The component design module 120 defines the components as hierarchical structures, input and output information, and performing functions, wherein the performing functions indicate basic actions of the components such as movement, rotation, signal transmission, and the like. A programming language such as C++, Java, or the like or a modeling language such as a unified modeling language (UML), a discrete event system specification (DEVS), or the like is used to define the components. Thus, the component design module 120 provides an interface through which a user, i.e., a system engineer, inputs program codes or diagrams to define or change the components. The component design module 120 also provides an interface through which input and output information of the existing components and parameters related to functions are changed, so that the system engineer may define the components using a variety of methods.

The scenario design module 130 selects components to be used for designing the ubiquitous system from the components generated by the component design module 120 and defines behaviors, positions, and directions of the selected components. Here, the behaviors refer to a series of actions which define functions performed by the components in a scenario. The system engineer may design a ubiquitous system through the scenario design module 130 and establish various types of design alternatives based on an initially designed ubiquitous system. For example, if an RFID tag is adhered to a product and an RFID reader is adhered to a conveyer in order to design a ubiquitous conveyer system for managing movement of the product, the component design module 120 may design the RFID tag, the product, the RFID reader, and the conveyer, and the scenario design module 130 may design movement paths of the product or the number and positions of RFID tags to design the whole ubiquitous conveyer system. Also, standards of the RFID tags, positions of the RFID reader, and the like may be adjusted to change an existing design. The changed contents of the design that are completed as described above are stored as a design alternative in a system model database (DB) 170.

The environment design module 110, the component design module 120, and the scenario design module 130 are respectively connected to an environment database (DB) 161, a component database (DB) 162, and a scenario database (DB) 163. The environment DB 161, the component DB 162, and the scenario DB 163 respectively store various resources of environments, components, and scenarios which are used by the environment design module 110, the component design module 120, and the scenario design module 130. The environment DB 161, the component DB 162, and the scenario DB 163 may add data generated by corresponding modules as new resources, freely read pre-stored resources, and use the pre-stored resources for designing.

The design advisor module 140 provides technical knowledge that the system engineer requires to design the ubiquitous system. For example, if the system engineer selects and places a sensor, the design advisor module 140 advises the system engineer of the awareness range, the installation method, and the like of said sensor. An engineer who lacks expert knowledge of the corresponding field may also be provided with expert knowledge necessary for designing by the design advisor module 140, and thus be able to perform more accurate designing.

The simulator 200 may be a discrete event simulator which is widely used by a general CAx tool. The simulator 200 includes a simulation engine 210, an external interface module 220, and a simulation result database (DB) 230. The simulation engine 210 simulates a performance or an operation of the ubiquitous system based on the environments and components selected for the ubiquitous system. The external interface module 220 provides an interface with an external tool. The simulation result DB 230 stores the simulation results.

Since the simulation engine 210 is able to change the environments and components of the ubiquitous system in order to repeat the simulation, the simulation engine 210 is able to handle a large scale event within a short time. Thus, the simulation engine 210 is able to use a fast event scheduling technique, a parallel processing technique, or the like. Examples of the fast event scheduling technique may include a technique for simplifying a multilayer ubiquitous system, into which a plurality of discrete event systems and continuous state systems are integrated, into a single layer discrete event system in order to simulate said single layer discrete event system, a technique for simulating only selected components of a whole system that are called by an event, and the like.

The external interface module 220 operates along with an existing expert network simulator in order to increase accuracy of a simulation, or is connected to a real device to use input information for the simulation. A standardized interface such as a distributed interactive simulation (DIS), a high level architecture (HLA), a transmission control protocol-internet protocol (TCP/IP) socket, or the like may be supported so as to operate the external interface module 220 along with various types of external devices.

The analysis system 300 statistically analyzes the simulation results of the simulator 200 and performs a what-if analysis to evaluate the design alternatives generated by the design system 100 and to recommend an optimal design alternative. The analysis system 300 includes a statistical analysis module 310, a what-if analysis module 320, an optimal design recommendation module 330, and a document generation module 340. An analysis result DB 350 is connected to the statistical analysis module 310 and the what-if analysis module 320 in order to store results of analyses which have been performed by the statistical analysis module 310 and the what-if analysis module 320.

The statistical analysis module 310 analyzes the simulation results using a statistical technique (a correlation analysis, a confidence analysis, or the like). The analysis results are stored in the analysis result DB 350 and are expressed in a report or chart form to support decision-making by the system engineer.

Each time the scenario design module 130 completely sets and changes design conditions of the design alternatives, the what-if analysis module 320 drives a simulator with respect to each of the design alternatives of a design alternative list stored in the system model DB 170 in order to compare and analyze simulation results obtained from the simulator. The what-if analysis module 320 provides a user interface for changing the simulation conditions of the design alternatives and drives the simulator based on the simulation conditions changed by a user in order to compare and analyze the simulation results of the design alternatives. The system engineer may change the simulation conditions, repeat the simulation, and rationally compare the design alternatives in various conditions through the what-if analysis module 320. Thus, the system engineer may easily identify an optimal design alternative.

The optimal design recommendation module 330 recommends an optimal design alternative based on the what-if analysis results of the design alternative list obtained through the what-if analysis module 320. If the what-if analysis is made, a simulation result is generated with respect to each of the design alternatives of the design alternative list. The simulation results include design parameters used for designing a system and system performance indexes. For example, if a what-if analysis is made with respect to an RFID system, design parameters such as the number, installation positions, and directions of RFID readers, and the like and system performance indexes such as recognition rates of RFID tags of the RFID readers, and the like are generated as simulation results of design alternatives. The system engineer defines objective functions using a combination formula of the design parameters and the system performance indexes so that the optimal design recommendation module 330 evaluates the design alternatives using the simulation results. The system engineer simulates a plurality of design alternatives automatically generated by the optimal design recommendation module 330 and evaluates the simulation results using the objective functions in order to automatically derive an optimal design alternative. Values of the design parameters of the design alternatives from the design alternative list are combined using an optimal algorithm such as a steepest descent algorithm, a genetic algorithm, or the like in order to automatically generate the design alternatives.

The document generation module 340 generates documents such as a blueprint, a bill of material (BOM), a specification, and the like of the optimal design alternative derived by the optimal design recommendation module 330. The system engineer obtains documents necessary for a virtually designed and verified system through the document generation module 340.

A CAD/CAE for a ubiquitous system according to the present invention, which is applied to a conveyer system including RFIDs, will now be described in more detail.

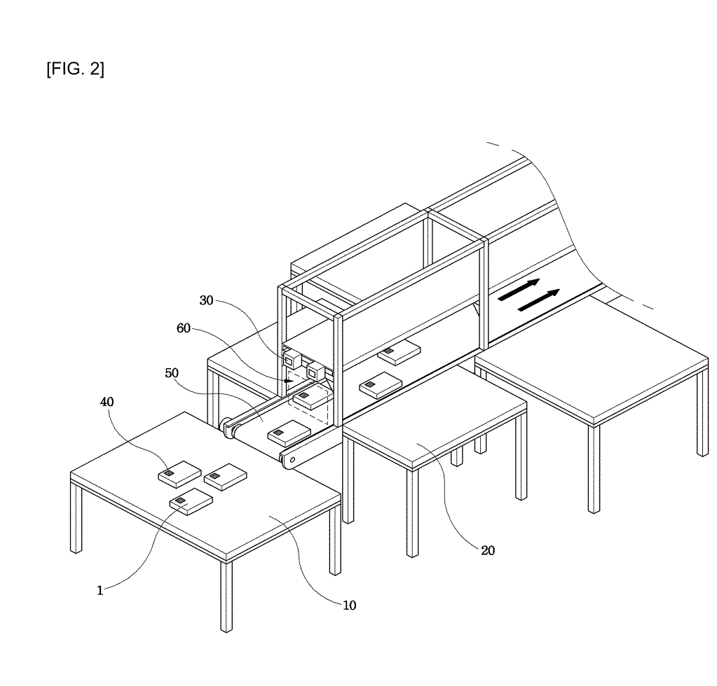

FIG. 2 illustrates a conveyer system using a CAD/CAE system according to an embodiment of the present invention. Referring to FIG. 2, the conveyer system according to the present embodiment includes a load table 10, a work table 20, and a conveyer belt 50. Here, a product 1 is loaded on the load table 10, moves on the conveyer belt 50, and experiences a series of processes as it reaches various positions of the work table 20.

It is assumed that in a ubiquitous system, a reader 30 accurately recognizes that a RFID tag 40 adhered to the product 1 moving on the conveyer belt 50 passes through a gate 60 in order to accurately check a moving state of the product 10. Here, the number of products 1 is limited to 10, and one RFID tag 40 is adhered to one product.

Before the ubiquitous system is installed in a real shop floor, a system engineer is to determine standards and disposition of equipment for obtaining a 100% recognition rate and to verify whether the ubiquitous system is capable of operating well according to a use scenario. For this purpose, the system engineer is to analyze and simulate the ubiquitous system using the number, positions, and directions of readers 30, an adhering position of the RFID tag 40, and product standards of the readers 30 and the RFID tag 40 as design parameters, so that the ubiquitous system will operate at an optimal performance.

In the present embodiment, a network simulation is performed between the RFID tag 40 and the reader 30 using an RFID protocol and a Friis transmission model of EPC Global. Also, a final selection standard of established design alternatives is set to a recognition rate (if the recognition rate is the same, the lowest cost design is selected as a design alternative).

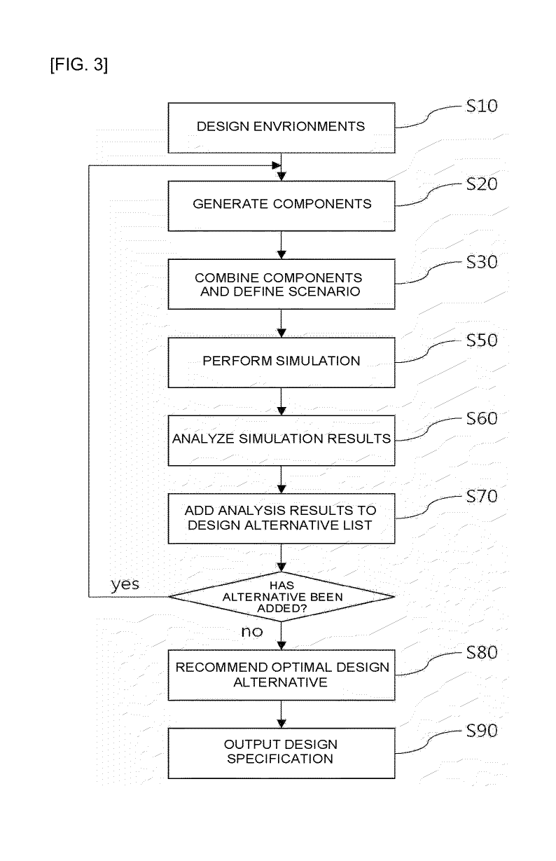

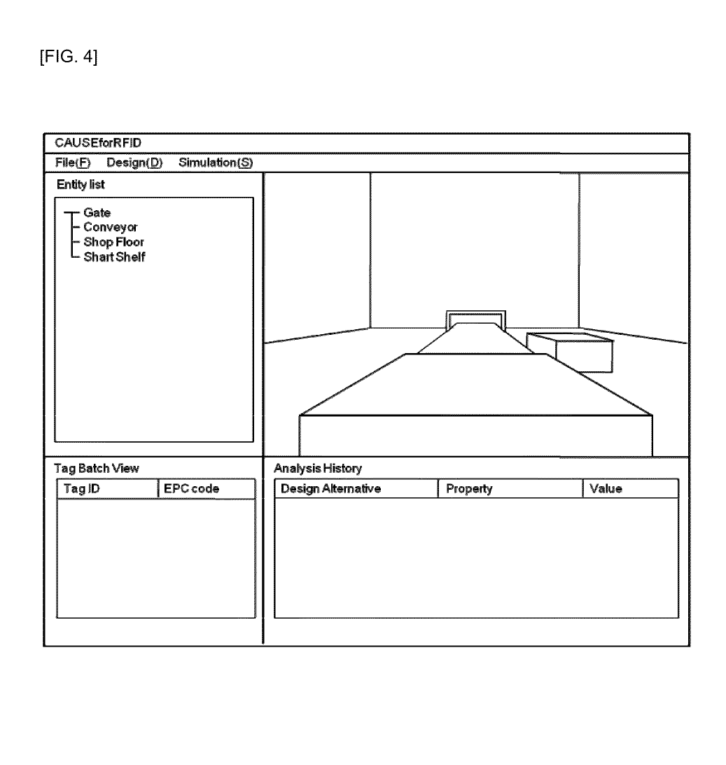

FIG. 3 is a flowchart of a process for designing and analyzing the conveyer system of FIG. 2. FIGS. 4 through 7B illustrate screens of a CAD/CAE system output in operations of the process of FIG. 3, according to embodiments of the present invention.

The process of designing and analyzing a ubiquitous system according to an embodiment of the present invention will be described in detail with reference to FIG. 3.

If a design is originated using the CAD/CAE system, in operation S10, new environments of the conveyer system to be designed are generated through the environment design module 110 or environments are read from the environment DB 161 to design environments of the ubiquitous system. As shown in FIG. 4, if new environments are generated or stored environments are read, environment entities of the corresponding environments are represented on a screen. Here, a main screen is divided into four windows, wherein the two left windows show environment entities and characteristics of a gate, a conveyer, a shop floor, and the like constituting environments. Components of an RFID tag, a reader, a product, and the like that will be generated in the component generating operation are represented as entities. The right top window 3-dimensionally displays arrangements of the environment entities to perform a simulation, and the right lower window displays analysis results of alternatives that are generated later.

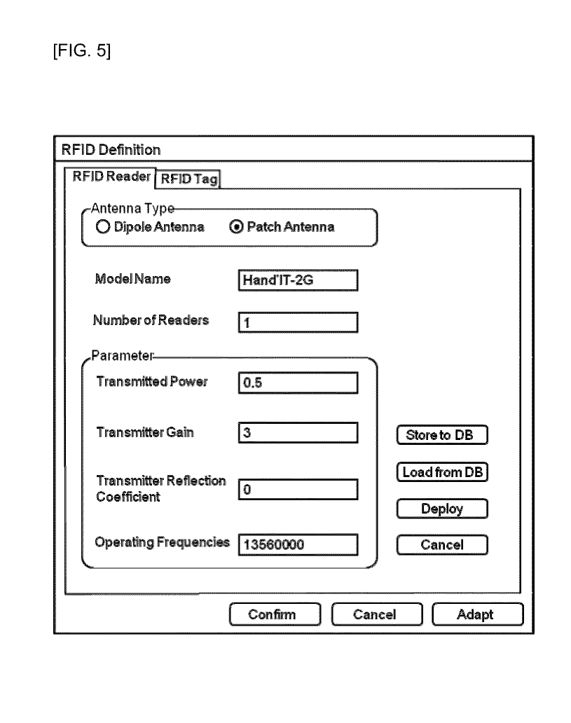

In operation S20, components of the ubiquitous system are generated through the component design module 120. An existing standard stored in the component DB 162 is selected or a new standard is defined through the component design module 120 in order to design the reader 30, the RFID tag 40, and the product 1. In the present embodiment, one “Hand'IT-2G” reader, 10 products, and 10 “PICOPASS 16K RFID tags” are generated. Here, a reader may set names and the number of models and input various parameters of a corresponding product such as transmission power, gain, and the like through a generation window provided as shown in FIG. 5.

In operation S30, the scenario design module 130 combines the components generated in operation S20 to physically design the whole ubiquitous system and defines behaviors of the components to define a scenario of the ubiquitous system. For example, a determination is made as to whether an RFID tag 10 is allocated to a generated product and which side of the product the RFID tag 40 is to be adhered to, an initial position and a movement path of the product are set, and the reader 30 is arranged in a desired position and direction. In the present embodiment, the RFID tag 40 is adhered to the top of the product, and one reader 30 is set in a direction of at an angle of 45°.

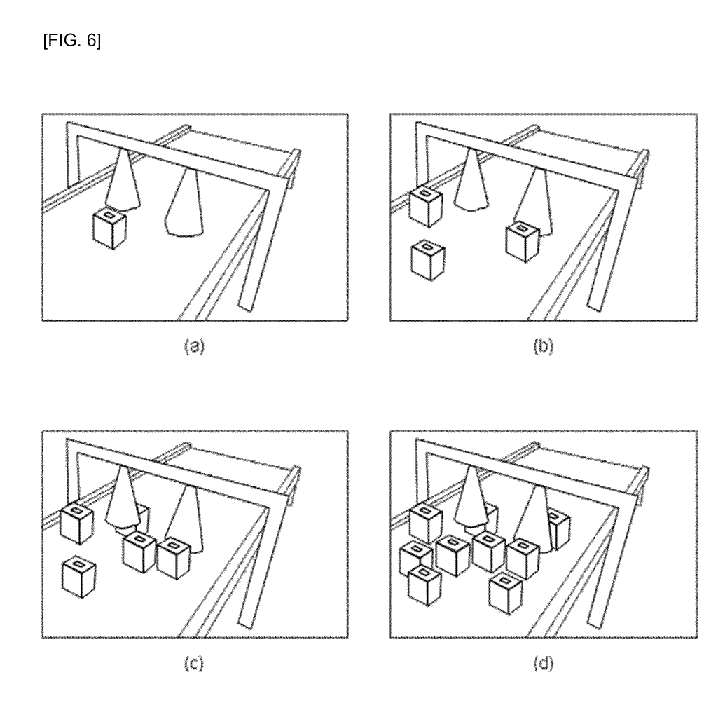

In operation S50, the simulator 200 operates according to the scenario set in operation S30 to simulate a performance or an operation of the ubiquitous system. As time elapses, moving states of products 1 and recognition states of a reader with respect to an RFID tag may be displayed on a 3-dimensional simulation screen. Here, the what-if analysis module 320 may effectively perform a what-if analysis with changes in simulation conditions and an analysis method according to the set scenario. For example, the number and positions or installation positions of readers 30, the adhering direction of the RFID tag 40, and the like may be changed to change the simulation conditions. In order to evaluate whether a product recognition function of a reader operates well according to the number of products 1 passing through the gate 60, the number of products 1 passing through the gate 60 may be changed to set a scenario by which many products are to pass through the gate at one time, as shown in FIGS. 6A through 6D. Various cases in which the RFID tag 40 is oriented downward, and the like may be set as scenarios so as to simulate the various cases. Here, the simulator 200 may compute a distance and an angle between the RFID tag 40 and the reader 30 at predetermined time intervals, compute a reception power of the RFID tag 40 using the Friis transmission model, and display whether the reader 30 successfully recognizes the RFID tag 40, on a simulation screen.

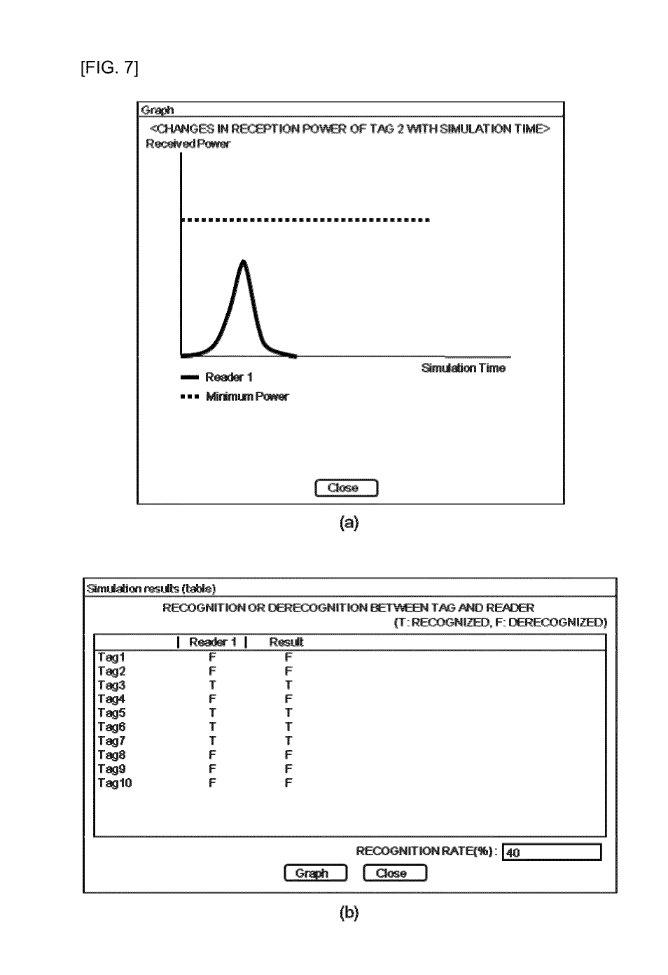

In operation S60, the what-if analysis module 320 analyzes the simulation results obtained in operation S50, stores the analysis results in the analysis result DB 350, and outputs the analysis results in a graph or chart form. In other words, as shown in FIG. 7A, changes in the reception power of the RFID tag 40 are shown on a graph, and a recognition or derecognition, a recognition rate, and the like between the reader 30 and the RFID tag 40 are shown in a table form as shown in FIG. 7B.

In operation S70, the ubiquitous system designed in operations S20 and 30 and the simulation and analysis results obtained in operations S50 and S60 are added as one design alternative to a design alternative list and stored in the system model DB 170. Information stored in the design alternative list includes data (i.e., the number, positions, and directions of readers and product standards of the reader and an RFID tag) set in operations S20 and S30 and the analysis results (i.e., the recognition rate), and the like obtained in operation S70.

The process returns to operations S20 or S30 to change the standards (i.e., standards between a reader and an RFID tag) of the components, or the design conditions (i.e., the number, positions, and directions of readers), or the like in order to repeat operations S50, S60, and S70 so as to generate a plurality of design alternatives using the repeated analysis of the simulation results.

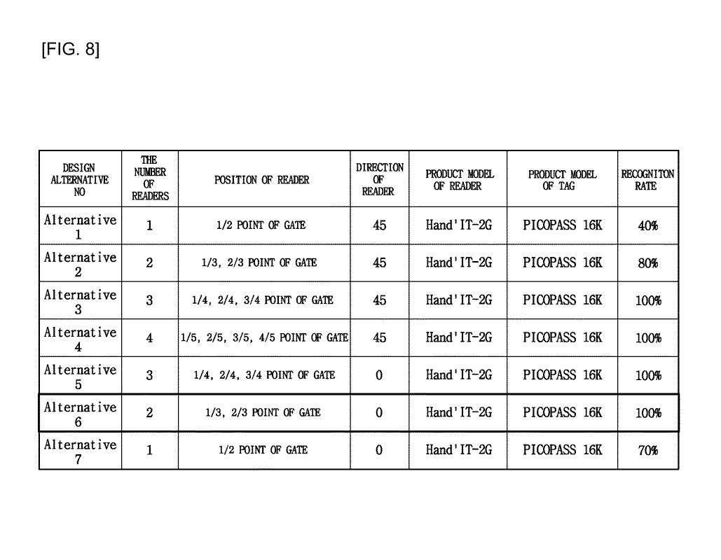

In operation S80, a sufficient number of design alternatives are generated through the above-described process, in particular, an optimal design alternative is generated in consideration of recognition rates and cost of the design alternatives through the optimal design recommendation module 330. For example, as shown in FIG. 8, a sixth alternative for satisfying 100% of recognition rate and installing the lowest number of readers 30 may be selected as an optimal design alternative.

In operation S90, the document generation module 340 outputs a detailed design specification for the optimal design alternative obtained in operation S80 in a screen or printed matter form so that a user may use the detailed design specification when developing a real ubiquitous system.

The above-described process of the present invention assists a system engineer to determine optimal design conditions through a simulation without needing to construct a real ubiquitous system. Also, the process supports the system engineer to systematically design, simulate, and analyze the ubiquitous system so as to select an optimal design alternative. In addition, the process supports the output of design specifications for defining and establishing conceptive scenarios so as to consistently perform a process of the whole ubiquitous system.

As described above, a CAD/CAE system and a method for designing and analyzing a ubiquitous system according to the present invention allows a user to repeatedly change design conditions so as to conveniently determine an optimal design alternative. Thus, a system engineer, who lacks expert knowledge of ubiquitous fields unifying various technologies, also will be able to design a high-quality ubiquitous system.

Moreover, the ubiquitous system is modeled in a flexible layer structure. Thus, the user can easily change components of the ubiquitous system as necessary and design a highly expansible ubiquitous system, regardless of the size of the ubiquitous system.

While the present invention has been particularly shown and described with reference to exemplary embodiments thereof, it will be understood by those of ordinary skill in the art that various changes in form and details may be made therein without departing from the spirit and scope of the present invention as defined by the following claims.

The embodiments of the invention in which an exclusive property or privilege is claimed are defined as follows:

1. A computer-aided design (CAD)/computer-aided engineering (CAE) system for designing and analyzing a ubiquitous system, comprising:
a design system for generating a system model in a 3-layer structure, the 3-layer structure comprising:
an environment layer defining environmental elements and physical structures of the ubiquitous system;
a component layer defining devices constituting the ubiquitous system; and
a scenario layer representing behaviors of components of the ubiquitous system, and re-defines the system model in order to define a plurality of design alternatives;
a simulator connected to the design system to simulate the system model designed by the design system; and
an analysis system connected to the simulator to analyze results of the simulation performed by the simulator and recommend an optimal design alternative.

2. The CAD/CAE system of claim 1, wherein the design system comprises:
an environment design module which supports a design of environments of the ubiquitous system;
a component design module which supports definitions of the components of the ubiquitous system and functions of the components;
a scenario design module which supports definitions of behaviors, positions, and directions of the components of the ubiquitous system to be used for designing the ubiquitous system among the components, wherein the definitions of behaviors, positions, and directions of the components are generated by the component design module; and
a design advisor module which provides a system engineer with technical knowledge necessary for designing the ubiquitous system.

3. The CAD/CAE system of claim 2, wherein the environment design module combines a building layout and physical phenomena elements, including temperature or humidity, by way of a 3-dimensional grid, and defines the environment layer.

4. The CAD/CAE system of claim 2, wherein the scenario design module allows a user to re-define the behaviors, positions, or directions of the components of the ubiquitous system so as to establish a plurality of design alternatives for the ubiquitous system.

5. The CAD/CAE system of claim 2, wherein the design system further comprises:
an environment database (DB) connected to the environment design module to store environment information generated by the environment design module;
a component DB connected to the component design module to store component information generated by the component design module; and
a scenario DB connected to the scenario design module to store scenario information generated by the scenario design module.

6. The CAD/CAE system of claim 1, wherein the simulator comprises:
a simulation engine which simulates one of a performance and an operation of the ubiquitous system based on the environments and the components of the ubiquitous system designed by the design system;
an external interface module which provides an interface with an external tool; and
a simulation result DB which stores the results of the simulation performed by the simulation engine.

7. The CAD/CAE system of claim 6, wherein the simulation engine performs the simulation using a fast event scheduling technique or a parallel processing technique.

8. The CAD/CAE system of claim 6, wherein the external interface module supports one of a distributed interactive simulation (DIS), a high level architecture (HLA), and a transmission control protocol-internet protocol (TCP/IP) socket interface in order to operate along with various types of external devices.

9. The CAD/CAE system of claim 1, wherein the analysis system statistically analyzes the results of the simulation performed by the simulator, performs a what-if analysis to evaluate the design alternatives generated by the design system, and recommends an optimal design alternative.

10. The CAD/CAE system of claim 9, wherein the analysis system comprises:
a statistical analysis module which analyzes the results of the simulation performed by the simulator using a statistical technique;
a what-if analysis module which drives the simulator with respect to each of the design alternatives established by the design system to compare and analyze the results of the simulations obtained by the simulator;
an optimal design recommendation module which recommends an optimal design alternative based on the results of the what-if analysis of a design alternative list obtained by the what-if analysis module; and
an analysis result DB which is connected to the statistical analysis module and the what-if analysis module to store the results of the analyses performed by the statistical analysis module and the what-if analysis module.

11. The CAD/CAE system of claim 10, wherein the what-if analysis module provides a user interface through which simulation conditions of the design alternatives established by the design system are changed, to drive the simulator based on the changed simulation conditions so as to compare and analyze the results of the simulations performed by the simulator.

12. The CAD/CAE system of claim 10, wherein the optimal design recommendation module receives a combination formula of a design parameter and a system performance index used for designing the ubiquitous system from the user, defines the combination formula as an objective function, and receives the design parameter and the system performance index as simulation results of each of the design alternatives from the what-if analysis module to evaluate the objective function so as to automatically derive an optimal design alternative.

13. The CAD/CAE system of claim 10, wherein the analysis system further comprises a document generation module which generates one of a blueprint, a bill of material (BOM), and a specification of the optimal design alternative derived by the optimal design recommendation module.

14. A method of designing and analyzing a ubiquitous system, comprising:
designing a current environment by generating new environments of the ubiquitous system to be designed or by reading pre-stored environments;
defining components by generating components of the ubiquitous system, wherein components are selected from pre-stored standards of the components or defined to be a new standard of the components;
setting a selected scenario by combining the components to physically design the whole ubiquitous system and defining the behaviors of the components;
simulating a performance or an operation of the ubiquitous system according to the scenario that has been set;
analyzing results of the simulation and outputting the analysis results in a graph or chart form;
adding and storing system information comprising the defined components and scenario, the simulation results, and analysis information of the simulation results as design alternatives of a design alternative list; and
deriving an optimal design alternative by comparing the analysis results of the simulation results of the design alternatives.

15. The method of claim 14, wherein simulating a performance or an operation changes simulation conditions and an analysis method according to the set scenario to perform a what-if analysis.

16. The method of claim 14, wherein deriving an optimal design alternative further comprises outputting a design specification of the optimal design alternative in a screen or printed matter form.
